(19) United States
(12) Patent Application Publication
(10) Pub. No.: US 2026/0299980 A1
(43) Pub. Date: Oct. 1, 2026

(54) MULTI-AGENT SYSTEM FOR USER ASSISTANCE IN MICROSCOPY SYSTEMS

(71) Applicant: Carl Zeiss Microscopy GmbH, Jena (DE)

(72) Inventors: Manuel AMTHOR, Jena (DE); Daniel HAASE, Zöllnitz (DE); Ralf WOLLESCHENSKY, Jena (DE)

(21) Appl. No.: 19/533,127

(22) Filed: Feb. 7, 2026

(30) Foreign Application Priority Data
Mar. 28, 2025 (DE) 10 2025 112 220.2

(51) Int. Cl. G06F 9/451; G02B 21/36; G06F 3/04847; G06T 7/00

(52) U.S. Cl. CPC G06F 9/453; G02B 21/365; G06F 3/04847; G06T 7/0012; G06T 2207/10056

(57) ABSTRACT

A multi-agent system includes a plurality of agents for providing user assistance information for the use a microscope. Generating the user assistance information includes using an agent system assigned to the microscopy system, wherein agents of the agent system are designed to process a respective subtask by interaction with one or more large learned text models and to generate the user assistance information jointly by mutual communication of corresponding processing results.

### RELATED APPLICATION DATA

This application claims the benefit of German Application No. 10 2025 112 220.2, filed Mar. 28, 2025, the disclosure of which is incorporated herein by reference in its entirety.

### TECHNICAL FIELD

Various aspects of the present disclosure relate to techniques for providing user assistance for the use of a microscopy system. Various examples of the present disclosure relate in particular to the use of an agent system comprising a plurality of agents for generating corresponding user assistance information for an associated user assistance request.

### BACKGROUND

Microscopy systems are used in a multitude of applications, e.g. for imaging semiconductor samples, for imaging biological samples such as cells or tissues, for examining composite materials, for inline testing of a production line, for end-of-line testing of a production line, in science and manufacturing, etc.

There are also a multitude of microscope types, including light microscopes, particle microscopes such as electron microscopes, helium ion microscopes, and atomic force microscopes. Even within a particular microscope type, there are a multitude of subtypes. For example, there are many different types of light microscopes, e.g. having different imaging modalities, different illumination configurations, different filters in the detection, etc. Phase or amplitude imaging is possible. Fluorescence or light sheet imaging are further possibilities. Sometimes a single microscope can be controlled to provide many different modalities from among such imaging modalities, e.g. by activating or deactivating the use of specific optical filters in the imaging path, by using a specific illumination configuration, and/or by specific post-processing of the images.

This variability between applications, coupled with the complexity of the hardware/software, makes it difficult to provide microscope users with tailored support or user assistance. For example, a microscope manufacturer may be faced with the task of providing overly comprehensive user manuals covering all different types of applications and microscope hardware/software configurations. On the other hand, such complex manuals make it difficult for the user to find the specific information in which they are interested.

Nevertheless, for optimal use of microscopy systems, users conventionally require a deep system understanding, for example regarding the set-up and functioning of the control software of the microscope or the graphical user interface by means of which the user carries out the control, and regarding the connection between the microscope control software and the respective hardware components. In addition, it is conventionally necessary to understand the physical-technical properties of the various imaging modalities supported by the microscopy system. One example thereof is the recording of a first image of a biological sample where the cells may be represented too dark. In such a case, various solution approaches can be pursued: The display parameters, such as the gamma settings, can be adapted. Alternatively, a computation algorithm, for instance the HDR algorithm, can be used to improve the image quality. A further option could be to start a new recording with a higher laser power or longer exposure time, or it is possible to select a different region of the sample and record it anew. The optimization of the process depends on numerous constraints. For example, a careful balance between sample conservation, image quality and recording time is required during recording. Moreover, the hardware components play a part, with their availability, type and state having to be taken into account. In addition, the specific properties of the sample, such as dye properties, should be taken into account.

### BRIEF SUMMARY

In view of this multitude of influencing factors, interactive, automated support for the user is desirable. Such a system could help the user to achieve better results in less time by providing the user with customized recommendations or proposals.

This object is achieved by the features of the independent patent claims. The features of the dependent claims define embodiments.

Aspects in connection with providing user assistance to a user of a microscopy system are disclosed below. For this purpose, the user can make a user assistance request, user assistance information then being generated in a software-implemented manner. For generating the user assistance information, an agent system comprising a plurality of agents (multi-agent system, MAS) is used, wherein each agent accomplishes a specific (sub)task of an overall task associated with the user assistance request, the agents can communicate among one another and typically an overarching coordination mechanism exists for coordinating the activities of the various agents.

A computer-implemented method for user assistance is disclosed. The user assistance relates to carrying out a microscopy task on a microscopy system. The method comprises obtaining a user assistance request. The user assistance request is connected with the microscopy task. On the basis of the user assistance request, the method comprises generating user assistance information. The method furthermore comprises using the user assistance information. Generating the user assistance information comprises using an agent system assigned to the microscopy system. Agents of the agent system are designed to process a respective subtask by interaction with one or more large learned text models and to generate the user assistance information jointly by mutual communication of corresponding processing results.

A large learned text model is a machine-learning model (referred to as large language model, LLM) that has been trained on a large amount of data and is able to generate text and give a user human-like answers. For example, a typical LLM is trained on the basis of a large amount of cross-domain text data, such as books, articles or web pages. LLMs known according to the prior art are based primarily on the knowledge in the data with which they were trained. To enable an LLM to accomplish domain-specific tasks that are not covered by its training data, it is possible to embed domain-specific context in the prompt. This technique is also known as Retrieval Augmented Generation (RAG). For RAG, for example, contextual information is retrieved from a knowledge database and embedded in the prompt to the LLM.

The various agents of the MAS may be associated with different executable functions and/or different rights. The various agents can at least partly access domain-specific models in order to accomplish the corresponding subtasks. By virtue of such techniques, the different agents have different abilities that enable them to accomplish the respective subtasks with which they are entrusted. The use of the MAS can also resolve user assistance requests with high complexity. As a result of the high system complexity of the microscopy system, corresponding user assistance requests often have a correspondingly high complexity.

Each agent is able to process, store and pass on data independently. Moreover, each agent accomplishes a specific subtask of the overall task and can potentially communicate with every other agent. This makes it possible to resolve user assistance request tasks that are too complex for conventional, isolated agents. This allows the user to interact with the microscopy system as if communicating with a human expert to assist the user in microscopy.

Communication between the agents is in principle also possible across different microscopy systems. This makes it possible to share found solutions to complex problems and thus to foster collaboration between different microscopy systems or different users or user groups. This decentralized procedure can resolve user assistance requests with high complexity, such as often occur on account of the high system complexity of the microscopy system.

In general, an agent can denote a logic module which is defined in software and which can accomplish specific tasks by interaction with one or more LLMs. For example, the agent can obtain, process, and/or transmit information. The agent can access a specific memory or context in order to make information available even across the processing of multiple tasks – for example in connection with the processing of multiple user assistance requests. The agent can access not just an LLM for processing texts, but also in some examples one or more models, for example machine-learned models, which allow processing and/or evaluation of microscope images. Examples include for example convolutional networks, transformer networks, but also traditional image processing models. The LLM can be used in particular for communication with other agents and/or the user.

The MAS can be implemented as software on one or more computers. Exemplary details concerning the implementation and creation of the MAS are discussed below: For example, the implementation of an MAS can comprise selecting a suitable framework or a suitable platform for the implementation of the MAS. This can comprise using Python-based libraries and frameworks such as LangChain, Auto-GPT, AgentPy, and Spade, or non-Python platforms such as JADE (Java-based), SARL, or Rasa, which concentrate on conversation AI. When designing the MAS, the integration of the LLM can be configured. This can include selecting suitable LLMs, such as language models, embeddings using vector databases – for RAG – such as Pinecone and FAISS, and also task-specific models for image processing tasks, classification, recommendation systems, etc. A further important aspect of implementing MAS is data management, which comprises the capture, storage, and retrieval of data. This can comprise using SQL or NoSQL databases such as PostgreSQL, MySQL, MongoDB or Redis, and also vector databases such as FAISS, Chroma and Pinecone for the processing of embeddings. Moreover, it is necessary to design data processing pipelines, including ETL tools for pre-processing.

Communication protocols and APIs can be selected in order to enable interactions between agents. This can comprise using RESTful APIs for agent communication, messaging queues, or event-driven architectures using technologies such as RabbitMQ or Kafka, and also agent-specific communication languages such as ACL (Agent Communication Language). The MAS can be designed in particular to enable communication between the agents by means of textual communication elements obtained by the interaction of the agents with said one or more LLMs.

One or more chat rooms can be provided to enable the agents to communicate. For example, an instance-specific chat room could be provided. This instance-specific chat room can be associated with the respective specific user assistance request. This means that there are different chat rooms for different user assistance requests. Alternatively or additionally, it would be conceivable for at least one cross-instance chat room to be provided. The latter can then comprise information for multiple user assistance requests or the task resolution of the different agents for multiple user assistance requests. In addition to such chat rooms, which are either specific to a specific user assistance request or non-specifically concern a plurality of user assistance requests, it would also be conceivable for one or more topic-specific chat rooms to be defined. Such topic-specific chat rooms can be associated with specific subtasks, for example. By way of example, different topic-specific chat rooms could be associated with different components of the microscopy system (for example a graphical user interface, a microscopy unit, a control module, etc.). By using a structure for the chat rooms, even with limited context length of the corresponding large machine-learned text models, it is possible to ensure that sufficient context information can be processed in the inference of the large machine-learned text models and that the agents can make better decisions.

Such chat rooms can either be designed to be transparent for the user, that is to say that a user does not see the communication between the different agents in said one or more chat rooms. Alternatively or additionally, it would however also be conceivable for a user to obtain access to said one or more chat rooms. For example, the chat history in one or more chat rooms could be output via a user interface. In this way, the traceability of the user assistance information for the user can be increased. This typically promotes the degree of acceptance of corresponding user assistance information by the user.

The decision and reasoning mechanisms of the agents can likewise be configured. These can range from simple rule-based systems or decision trees to advanced machine learning (ML) planning machines, symbolic reasoning tools, or LLM-based reasoning through prompt engineering or fine tuning of language models. In order to enable task execution and integration with external systems, other MAS or external knowledge databases, agents can be configured to interact with APIs for web services, CRM systems, ERP systems, automation tools such as Zapier and IFTTT, and robotic process automation (RPA) tools such as UiPath and Automation Anywhere. In addition, monitoring, assessment and logging mechanisms can be designed to track and/or assess agent performance (for instance by means of a scoring system). This can comprise using monitoring frameworks such as Prometheus, Grafana, or Datadog, logging and alerting by systems with ELK Stack, Splunk or Logstash, and the regular assessment of agent behaviour by way of performance analyses for optimization purposes. Moreover, security and data protection measures can also be implemented in order to ensure robust system protection. This includes authentication and authorization mechanisms such as OAuth and JWT tokens, data encryption, secure API endpoints, and compliance with relevant regulations such as GDPR, HIPAA, etc.

The provision and design of the hardware infrastructure can comprise the choice between cloud hosting and local hosting, for example. Containerization with Docker and Kubernetes can be used for scalability or serverless architectures. Finally, an optional user interface can be designed to facilitate user interaction with the MAS. This could comprise web-based dashboards, chatbot interfaces, web applications or command-line interfaces and APIs.

In summary, the MAS is designed – by such and further techniques – to generate user assistance information by accomplishing specific subtasks by interactions with LLMs and other relevant data processing tools. The agents communicate with one another and share their respective processing results in order to jointly create comprehensive and accurate user support information. This collaborative approach enables the resolution of complex user requests that would be a challenge for isolated agents, and promotes an interactive and adaptable support system tailored to the needs of microscopy users.

Various overall tasks are conceivable which are to be accomplished by the MAS. The type of overall task to be accomplished depends in particular on the type of user assistance request. For example, the user assistance request could be directed towards how the microscopy system can fully automatically capture the image of a specific sample under given constraints, such as a specific resolution, the need to conserve the sample or a specific speed. In a further example, the user assistance request could be directed towards how to be able to set the optimal microscope parameters for an experiment. The user assistance request could also concern carrying out a specific image processing task in the digital post-processing of previously captured microscopy images by means of microscopy software of the microscopy system. For example, the user assistance request in this context could concern the optimal setting of the parameters of the corresponding image processing algorithm or else the generation of program code for the execution of a customized image processing algorithm.

In light of this overall task described above, different subtasks undertaken by the different agents are conceivable. In particular, different types of agents can be used in the MAS in connection with these different subtasks. Different types of agents are entrusted with different subtasks. This means that the agent is designed by the MAS in such a way that the agent obtains specific target stipulations and/or constraints in order to recognize and accomplish that subtask. For example, such target stipulations and/or constraints can be explicitly stored in a memory which the MAS can access, for example by means of a textual description, which is then interpreted by the respective large learned text models. Alternatively or additionally, such target stipulations can also be generated by a communication agent, for example dynamically for each user assistance request. Text which is indicative of such a target stipulation can then be transferred to the respective agents of the MAS, for example in a chat room or forum, so that the LLM with which the respective agent interacts understands – by means of this dynamically generated target stipulation – which subtask is to be accomplished.

In one example, a communication agent of the MAS is entrusted with acquiring prior knowledge concerning the microscopy task.

The communication agent for acquiring the prior knowledge concerning the microscopy task can be entrusted with communication with one or more further communication agents of one or more further MAS assigned to one or more further microscopy systems.

By means of the communicative exchange between a plurality of MAS associated with different microscopy systems, the horizon of prior knowledge for each MAS can be extended. The available prior knowledge can be extended to include the respective prior knowledge acquired only in connection with a specific microscopy system. In particular, different users or user groups typically often use different microscopy systems. By means of the exchange between the corresponding MAS, such "best practices" or practical prior knowledge acquired by the respective users or user groups can also be made available to other users or user groups.

In particular, it would be conceivable for the different microscopy systems and the microscopy system to be connected to one another in a local network or via the Internet. In other words, it is conceivable for the microscopy systems to which the MAS that communicate with one another are assigned not to be arranged in a common local environment, but rather to be arranged in a spatially and/or network-logically separated manner.

Although the different microscopy systems can be located in different environments, it would be conceivable for the different MAS associated with these different microscopy systems to be implemented on the same platform, for example in the same cloud environment. However, it would also be conceivable for the different MAS associated with these different microscopy systems to be implemented in different application environments, for example on local computer hardware in the respective environment of the microscopy system ("on-premise"). In such a case, the different application environments require communication access, for example via the Internet.

It is conceivable for these different microscopy systems to be of different types. As a concrete example, a specific user assistance request could be processed by means of an MAS assigned to a microscopy system comprising a light microscope. At the same time, however, it would also be conceivable for this MAS then to communicate with one or more other MAS in order to solve the problem defined by the user assistance request, wherein these MAS are assigned to one or more other microscopy systems comprising e.g. other forms of microscope units, such as e.g. laser scanning microscope unit, light sheet microscope unit, etc. This is because sometimes it may turn out that the solution to a specific user assistance request is to inform the user that the corresponding microscopy task can be better accomplished with a different microscopy system of a different type.

Various aspects in connection with a communication agent of the MAS have been described above. The communication agent is entrusted with acquiring prior knowledge concerning the microscopy task. Alternatively or additionally, there may be a privacy agent entrusted with monitoring and enforcing a confidentiality policy when the communication agent communicates with one or more further communication agents. In this way, it is possible to ensure that sensitive or protected data, for example microscope images themselves or information about specific settings that are marked as sensitive by the user, are not transferred by the MAS as prior knowledge to other MAS.

However, the communication agent can acquire the prior knowledge not only by communicating with one or more other MAS, but also for example by accessing at least one knowledge database associated with the microscopy system. For example, RAG techniques could be used to acquire the prior knowledge.

The at least one knowledge database can comprise a plurality of knowledge elements represented in a machine-learned feature space. For example, coded feature vectors can provide particular microscopy-specific knowledge that is helpful in resolving the user assistance request.

It is conceivable for such a knowledge database to be maintained continuously. For example, the knowledge database could be continuously extended by positive and/or negative examples of user assistance information – if appropriate in connection with the associated user assistance request – being stored in the knowledge database.

For this purpose, it would be conceivable for the MAS to comprise an accountant agent entrusted with maintaining and/or extending the at least one knowledge database on the basis of user feedback on the user assistance information.

In general, in the various examples described here, the user feedback can be explicitly obtained from the user, e.g. by the user, after obtaining the user assistance information, giving user feedback ("thumbs up" versus "thumbs down") via a suitable graphical user interface and thus indicating whether the user assistance information was suitable in practice for resolving or answering the user assistance request. However, such user feedback could also be implicitly obtained from the user. For example, it would be possible to monitor how the user uses a graphical user interface of the microscopy system after the user assistance information has been provided. If the user uses the graphical user interface in accordance with the instructions specified in the user assistance information, this can be interpreted as an indicator that the user positively assesses the usefulness of the user assistance information.

Such or other mechanisms can then be implemented by the accountant agent, with the latter querying e.g. whether corresponding user feedback is available - implicitly or explicitly. The accountant agent could also check whether corresponding knowledge elements are already present in the knowledge database in order to avoid such duplicates. For example, the accounting agent could ensure that specific new knowledge elements to be included in the knowledge database are at a specific distance from knowledge elements already present in the knowledge database. The accountant agent could also enforce a specific format or a specific structure for the knowledge elements in the knowledge database.

Examples of such knowledge elements are user manuals for one or more components of the microscopy system. For example, a user manual for a graphical user interface of the microscopy system can be included in the knowledge database. For example, a user manual for a microscope component, for example for a light microscope or a laser scanning microscope, could be included in the knowledge database. Further examples of knowledge elements are historical user assistance requests and/or historical user assistance information. For example, historical pairs of user assistance requests and associated user assistance information can be stored, and it would optionally be possible to mark such historical pairs as positive examples or negative examples. Further examples of knowledge elements include technical articles, Wiki articles, or log files of one or more components of the microscopy system. In addition to such microscopy system-specific knowledge elements, it would also be conceivable for user-specific information to be kept available in the knowledge database. For example, it would be conceivable for information concerning specific preferences of the respective user to be kept available. This allows user assistance information to be provided that is better aligned with the preferences of the respective user. A further example of user-specific information concerns the use of an indicator for the skill level of the respective user. Such techniques are based on the insight that some users may already have very extensive experience with operating a specific microscope system, while other users are comparatively inexperienced. The complexity of the user assistance information can then be adapted to the skill level of the respective user. For example, it would be possible to ensure that comparatively skilled users are instructed to carry out specific routine steps only relatively concisely. For less skilled users, the corresponding instruction can have a greater level of detail even for routine steps. As an alternative or in addition to such microscopy system-specific knowledge elements and/or such user-specific knowledge elements in the knowledge database, the knowledge database can also contain sample-specific information in the form of corresponding knowledge elements. It is thus possible to provide information concerning specific constraints during the examination of the sample. For example, specific samples may be sensitive to light and only tolerate a specific light dose. Such information can be used to provide the user assistance information in a manner adapted to specific constraints or limitations in handling the respective sample. It would also be conceivable for information concerning a manufacturing process associated with the sample to be provided in the form of knowledge elements in the knowledge database. For example, specific manufacturing steps that the respective sample has undergone could be indicated. However, it is also conceivable for specific constraints of the manufacturing process to be indicated. In this way, it is possible e.g. to ensure that during in-line testing of a sample during the manufacturing process, the manufacturing process is delayed only for a specific permissible time or test modalities that would otherwise adversely influence the manufacturing process are not applied.

In general, the method can comprise obtaining user feedback on the user assistance information. The user assistance request and/or the user assistance information and/or the user feedback can then be stored in the knowledge database. For example, storage could be effected selectively depending on the user feedback. For example, positive examples or negative examples could be stored in a targeted manner.

A further type of agent is the so-called GUI agent. The GUI agent of the MAS can be entrusted with access to a configuration interface of a graphical user interface of the microscopy system. In this way, for example, the GUI agent can query a configuration of the graphical user interface and/or set the configuration of the user interface. For example, the GUI agent could query which interface elements (for example buttons, sliders, menus, submenus, workspaces, etc.) are visible in the graphical user interface. The GUI agent could also query positions of corresponding interface elements. The GUI agent could also display, position, or hide specific interface elements. By means of such techniques it is possible to tailor the user assistance information in a targeted manner to the specific circumstances of the graphical user interface of the microscopy system. Especially for inexperienced users, it may be possible in this way to provide a precise instruction as to where to find a specific interface element in the graphical user interface. For example, a graphical highlighting of a specific interface element to be actuated could be output to the user. A step-by-step instruction as to where the user should click in the graphical user interface or otherwise interact with the graphical user interface can be provided.

Yet another type of agent is the so-called control agent. A control agent of the MAS can be entrusted with access to a control module of at least one microscopy unit of the microscopy system. The control module can be designed to configure and trigger an image capture of microscope images by means of the microscopy system. The control module can be implemented in hardware and/or software, for example. The control module can have access to one or more components of the microscopy unit of the microscopy system, for example to an illumination module, a sample holder and/or a camera. For example, the control module can insert specific movable elements into the beam path or remove them from the beam path. For example, the control module could insert specific filters into the beam path and remove them from the beam path. The control module could e.g. rotate or adjust an objective turret in such a way that a specific objective is selected, so that an automated image capture can be triggered with the aid of the control agent. Not only is it possible for the image recording to be triggered in an automated manner, but it is also possible for specific image recording parameter values to be selected. The image capture can be carried out with a specific imaging modality. For example, phase contrast imaging could be carried out. For example, phase contrast imaging could be effected by means of hardware phase contrast or digital phase contrast. For example, fluorescence imaging with a specific wavelength of light could be selected. For example, tiled imaging could be carried out with a specific number of mosaic images.

As described above, the user assistance information can take the form of an instruction - written in text form, for example - to the user for operating specific interface elements of a graphical user interface. The user assistance information can generally be the user instruction to carry out specific settings on a microscopy unit or on the graphical user interface of the microscopy system. The user assistance information could also comprise specific recommendations, for example for using other types of microscopy systems. A further type of user assistance information comprises program code. Such program code can be used by a control module or an image evaluation module of the microscopy system. With the aid of the program code, specific tasks can be carried out in an automated manner.

A program code agent of the MAS can be entrusted with generating program code. For example, the program code can be written as a script language that can be transferred to an image evaluation module via an API. The program code could also be compilable or compiled. The program code can be used to carry out specific complex tasks in connection with image capture and/or image evaluation. For example, during image evaluation, a sequence of specific filters or manipulation operations could be applied to captured microscope images specified by the program code.

For the program code agent to create the program code, it may be helpful if the knowledge database discussed above contains knowledge elements that comprise examples of such program code. For example, the knowledge database could contain a knowledge element that relates to a program code documentation for generating the program code. Possible functions, their inputs and outputs, etc., could be stored there. A further knowledge element in the knowledge database could relate to a policy for the creation of the program code, for example. For example, it would be possible to indicate how specific comments should be stored in the program code in order to make the program code user-intelligible.

A coordination agent of the MAS can be entrusted with coordinating one or more further agents (for example one or more agents as discussed above, i.e. for example the GUI agent, the control agent, the communication agent, etc.) of the MAS. The coordination can be effected in such a way that the different agents are entrusted with the processing of a respective subtask. The coordination agent can coordinate a sequence of the processing steps by the different other agents.

A user interaction agent of the MAS can be entrusted with user interaction with a user. For example, this user interaction can serve for obtaining further context information concerning the user assistance request. For example, specific background information or detailed information could be queried from the user. This can serve to better understand the user's actual intent and thus to better adapt the user assistance information to the user's needs. The user interaction agent can take into account specific constraints when dealing with the user. For example, the user interaction agent can take into account user-specific information from the knowledge database when interacting with the user. For example, the user interaction agent can address more complex or less complex questions to users with different levels of experience. The user interaction agent can set the language of the questions to the user depending on information concerning the respective user's native language.

An image analysis agent of the MAS can be entrusted with evaluating microscope images captured by means of the microscopy system by access to one or more image processing models. Such image processing models can be traditional models which, for example, set a contrast or a brightness histogram of the respective microscope image. However, the image processing models can also be machine-learned. For example, it is possible to use complex machine-learned models that carry out specific semantic evaluation tasks on the microscopy images. For example, such models could carry out a segmentation of specific structures or structure types in the microscopy images. For example, specific cells or cell types could be segmented. An instance segmentation could be carried out. A centre point localization of specific structure types could be carried out. A defect analysis could be carried out. Defects could be localized. A defect density map or other density maps could be determined for specific structure types. It would be conceivable to determine statistics concerning specific structure types. For example, a degree of confluence or a count of cells could be carried out. For example, a defect density could be calculated.

For such and other tasks in connection with image analysis, the image analysis agent can interact with one or more corresponding image processing models. Examples of image processing models comprise for example transformer-based deep neural networks or deep neural networks with convolutional layers.

Various specific agents of the MAS have been discussed above. Generally speaking, it would be conceivable for the agents of the MAS to be entrusted to act adversarially in the processing of the respective subtask. Alternatively or additionally, specific agents of the MAS can be entrusted to act collaboratively in the processing of the respective subtask.

The terms "acting adversarially" and "acting collaboratively" can relate to specific modes or behaviours that agents within an MAS demonstrate when processing subtasks in connection with the creation of user assistance information. These terms describe how agents interact with one another as they execute their respective goals.

Acting adversarially can relate to a mode in which one or more agents question or examine the approaches, assumptions or results generated by other agents. This can be particularly useful in identifying potential vulnerabilities, errors or distortions in the solutions proposed by other agents. For example, an agent behaving adversarially could test the robustness of a proposed parameter setting for a microscopy system by assessing it under various conditions or by highlighting alternative approaches that might lead to better results. Such behaviour can optionally be used to ensure that the user assistance information overall is well validated and reliable.

On the other hand, acting collaboratively can relate to a mode in which agents work together in a coordinated manner to achieve a common goal. This can comprise exchanging information, combining expert knowledge, or using the results of the other agents to create comprehensive and accurate user assistance information. For example, one agent could specialize in image analysis, while another could concentrate on optimizing microscope settings, with both agents working together to provide a consistent recommendation to the user. Collaborative behaviour can be particularly useful if there is a need to accomplish complex tasks that require different skills or knowledge, and at the same time the intention is to ensure that the end result is greater than the sum of the individual contributions.

For example, it would be conceivable for a plurality of agents of the MAS or else a plurality of MAS instances to be questioned about a specific task definition or to accomplish a specific subtask. Corresponding answers can then be merged. In particular, merging such answers can involve weighting the answers relative to one another, wherein this weighting regulates the degree to which the respective answer is taken into account in the consolidated overall result. There are various possibilities for implementing such a weighting. For example, a majority decision would be possible. A relative or absolute majority can be taken into account. This can in turn be done by using a corresponding agent entrusted with merging multiple answers from various other agents. Alternatively or additionally, a so-called scoring system could be used, in which the different agents are entrusted with a score, which then defines the weighting. A corresponding score can be determined for example on the basis of user feedback or (pseudo-)labels concerning earlier operations involving the different agents.

These interaction modes – whether adversarial or contentious, or collaborative – can be determined dynamically on the basis of the specific requirements of the user request and the type of subtasks associated therewith.

One example of agents acting conflictingly or adversarially within an MAS in order to provide user assistance information may be a scenario in which two agents have the task of optimizing the microscope settings for imaging a light-sensitive biological sample. The first agent might propose increasing the laser power in order to improve the image brightness, while the second agent might challenge this approach by pointing out potential risks such as photobleaching or damage of the sample. This conflicting interaction enables the agents to iteratively refine their recommendations and ultimately propose alternative strategies, such as e.g. reducing the exposure time or using a detector with higher sensitivity. This contradictory process ensures that the final user assistance information is comprehensive and takes multiple perspectives into account.

One example of collaboratively acting agents might be that three agents work together to support a user in recording high-resolution images of a semiconductor sample. A control agent might propose optimal focus settings, while an image analysis agent assesses the sharpness of a test image and recommends adaptations. At the same time, a communication agent might give the user clear step-by-step instructions on the basis of the combined results of the other agents. By exchanging information and coordinating their efforts, these agents together ensure that the user obtains comprehensive guidance tailored to the user’s specific task. This collaborative approach enables the MAS to effectively address complex microscopy challenges.

For example, the method could furthermore comprise obtaining user feedback on user assistance information. Depending on the user feedback, a fine-tuning training could then be executed for at least one machine-learned model to which at least one agent of the MAS has access (for example the LLM or a domain-specific network). For example, a LORA fine-tuning training could be executed.

The user feedback can thus be used not just – as described above – in connection with the maintenance of the knowledge database. Alternatively or additionally, user feedback can also be used to improve the performance of individual agents by adapting the corresponding models. One example would be the fine tuning of an image processing model on the basis of user feedback. For example, the initial user assistance information could provide the user with a segmentation mask for specific structures in a microscope image. The user can then adapt this segmentation mask by, for example, excluding specific regions from the segmentation mask and adding other regions to the segmentation mask. In this way, it is possible to obtain basic information for the segmentation, which is then used for fine tuning.

Fine tuning training or fine tuning can be understood to mean an optional process for further optimizing one or more ML models by adapting their parameters on the basis of additional data or specific tasks. In particular, the fine tuning can consist in subjecting a pretrained model, which has been trained on a broad data set, to further training on a smaller, task-specific data set in order to adapt the performance of the model for a specific use case. This approach is often used in machine learning to leverage the knowledge gained from general pretraining while at the same time improving performance on specific tasks relevant to the respective application.

LoRA can refer to the low-rank adaptation of neural networks, a technique used for efficiently fine tuning large language models or other machine learning models. LoRA involves adding low-rank matrices to the weight layers of the model, thereby enabling the model to be parameter-efficiently adapted to new tasks without the need for complete retraining. This approach can considerably reduce the computational and storage requirements associated with fine tuning, and is therefore suitable particularly for scenarios where resources may be limited or where rapid adaptation is desired.

As already described above, there are various possibilities for obtaining corresponding user feedback, e.g. for the fine-tuning training. In general, it would be conceivable for the method to furthermore comprise monitoring a user interaction with a graphical user interface of the microscopy system after using the user assistance information. The user feedback can then be determined on the basis of monitoring the user interaction. In this way, without explicit indication of the user feedback by the user, the user feedback can be implicitly determined by monitoring the user's interaction with the microscopy system after using the user assistance information – for example after the user assistance information has been output to the user.

An electronic data processing device is also disclosed, which is designed to execute such methods as described above.

The features set out above and features described below can be used not only in the corresponding combinations explicitly set out, but also in further combinations or in isolation, without departing from the scope of protection of the present invention.

### BRIEF DESCRIPTION OF THE FIGURES

FIG. 1 schematically illustrates a system comprising a microscopy system and an electronic data processing device in accordance with various examples.

FIG. 2 is a flowchart of one exemplary method.

FIG. 3 schematically illustrates an MAS.

### DETAILED DESCRIPTION

The above-described properties, features and advantages of this invention and the way in which they are achieved will become clearer and more clearly understood in association with the following description of the exemplary embodiments which are explained in greater detail in association with the drawings.

The present invention is explained in greater detail below on the basis of preferred embodiments with reference to the drawings. In the figures, identical reference signs designate identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to a person skilled in the art. Connections and couplings between functional units and elements illustrated in the figures can also be implemented as an indirect connection or coupling. A connection or coupling can be implemented in a wired or wireless manner. Functional units can be implemented as hardware, software or a combination of hardware and software.

A description is given below of techniques for enabling user assistance to be provided when operating a microscopy system. In particular, a description is given of techniques for creating user assistance information for a user. The user assistance information is created in response to a corresponding – explicit or implicit – user assistance request.

A description is given below of techniques that can be used to generate different types of user assistance information. For example, the user assistance information can comprise an operating instruction for using one or more user interface elements of a graphical user interface of the microscopy system. Alternatively or additionally, the user assistance information can comprise program code for a control module of at least one microscopy unit of the microscopy system and/or for an image evaluation module of the microscopy system. The user assistance information can comprise for example a setting of one or more hardware or software parameters for image recording and/or for image processing of microscopy images by means of the microscopy system. For example, the user assistance information can comprise a user instruction for outputting to a user.

By means of the techniques described herein, an MAS comprising a plurality of agents is used to generate the user assistance information. The MAS can be assigned to a specific user or can be accessible to multiple users.

The agents within the system can communicate by way of various forms, including natural language in text form. This form of communication is advantageous since it allows humans to easily interpret and influence the exchange of information. Text communication can also take place in a technical language such as XML or similar formats. Moreover, mixed forms of communication are also possible, and in some cases communication can be encrypted in a latent space that is compact but may be difficult for users to interpret. The form of communication can also be dynamically defined by the agents themselves.

Coordination mechanisms between agents can take diverse forms. Direct one-on-one conversations are possible, as are interactions in chat rooms, which may be unmoderated or moderated by a superordinate entity, generally another agent. Forums provide a permanent space for interaction where agents can access and contribute to discussions at a later time. These forums can be instance-specific, can be associated with specific user requests or can be cross-instance and can comprise multiple requests. It is also possible to provide topic-specific channels that concentrate on specific subtasks or components of the microscopy system, such as e.g. the graphical user interface or imaging modalities.

Learning enables the MAS to adapt to new challenges and changing environmental conditions. Agents can learn from static knowledge sources such as manuals, Internet resources, training materials, or live information embedded in prompts. Learning can done by supervised or reinforcement learning, where models are refined or trained with the aid of external databases such as those used in RAG (Retrieval-Augmented Generation) models.

Feedback mechanisms further improve learning. Implicit feedback can be derived from image quality assessments in which images are automatically stored or discarded depending on usefulness. Explicit feedback comprises user-provided assessments, natural language inputs, or specific improvement proposals.

Agents can also share knowledge directly with one another in the event of information requests, which facilitates collaborative problem resolution. These feedback mechanisms enable the system to refine its answers and adapt over time to the needs of the users.

Agents can act in various modes, e.g. adversarially or collaboratively, when processing subtasks. Adversarial behaviour includes questioning or examining approaches proposed by other agents, which can contribute to identifying vulnerabilities or prejudices in solutions. Collaborative behaviour, on the other hand, includes coordinated efforts to achieve common goals, combining expert knowledge and results in order to offer comprehensive support. These interaction modes can be defined dynamically depending on the type of task and the user request. For example, agents can collect scores (from other agents or user feedback) that determine agent confidence and over time encourage good solution finders among the agents.

The different agents can be entrusted with different subtasks.

The MAS described here can be designed in such a way that it undertakes a multiplicity of subtasks in connection with the operation of a microscopy system. For example, agents within the system can communicate with the user by accepting tasks, asking questions, or conveying intermediate results. Moreover, agent coordination is possible, allowing agents to ask other expert agents for possible solutions, make dynamic decisions on the basis of available information, and re-assess those decisions as new relevant data emerge. Agents can also carry out image analyses, including network inference or training activities. For example, an agent can trigger or request the inference of a specific model. For example, an agent could control a corresponding execution environment of a corresponding model in order to trigger an inference of the model. An agent can also be entrusted with training a specific model. For example, an agent can collect, assess and/or curate specific training samples and then initiate a training on the basis of a training data set obtained in this way. For this purpose, for example, the agent can obtain access to a corresponding training environment for a model, which can be used to apply machine learning techniques or else other techniques to parametrize the model. Furthermore, agents can query text documents or databases such as manuals or online materials in order to provide answers to user requests. A further possible subtask is GUI recognition, where agents can determine the function of individual buttons or other elements in a user interface. Agents can also actuate hardware components, e.g. start image recordings, adapt laser power, change contrast settings, or change objectives. In addition, the system can provide sensor values for various hardware parameters. Creating program code, including macro code for controlling microscope operations, is a further potential subtask that can be undertaken by agents within the system. Finally, agents can provide explanations or substantiations for their proposed actions in order to ensure transparency and facilitate user understanding. These capabilities enable the MAS to comprehensively support users in operating the microscopy system. Each such subtask mentioned above can be implemented by one or more corresponding agents. For example, a specific subtask could be undertaken by two adversarially acting agents.

A description is given below of some exemplary and concrete implementation variants for generating user assistance information by means of an MAS.

In a first implementation variant, the MAS can act as an assistance system for setting microscope parameters on the basis of knowledge databases. The basic concept underlying this variant is an MAS comprising at least one agent which optimally sets up microscope parameters using an experiment description or a user request with use of a knowledge database. This knowledge database can be filled by reading from various sources such as manuals, scientific articles, web-based training materials, video tutorials, image databases (which may contain atlases with corresponding microscope settings) and contributions for instance from hardware specialists that provide parameter limit values and other technical details. Knowledge elements can be extracted not just from a structured knowledge database. Alternatively or additionally, it would also be conceivable for knowledge elements – such as manuals, scientific articles or training materials, as discussed above – to be extracted from an unstructured knowledge database. One example of an unstructured knowledge database would be for example a forum where a plurality of forum participants communicate with one another on a topic-related basis, for example, via forum entries. One or more agents can obtain access to such a forum, for example via the Internet. It would also be possible for the agents themselves to write contributions into such a forum for the purpose of acquiring prior knowledge, for example in order to ask questions and/or to assist other forum participants in answering a question. The forum participants can be other agents. However, it would also be possible for the agents to communicate in forums where humans also participate as forum participants. Agents of the MAS can specialize in specific subtasks, including GUI interaction, knowledge acquisition and storage, hardware monitoring (e.g. specific performance specifications for hardware components, etc.) and hardware actuation to execute commands or generate control code for the microscope, such as e.g. macro program code or scripts.

A second implementation variant builds on the first implementation variant, but introduces the ability for communication between microscopy systems, especially in scenarios where static knowledge is insufficient and learning is required. In this case, MAS assigned to different microscopy systems can exchange information about natural language or technical formats such as XML, which is facilitated by large language models (LLMs). This communication can take place within a common platform, such as a chat room or forum, where agents can participate in topic-specific discussions (e.g. high-resolution imaging) or have one-on-one conversations to clarify specific questions. Such interactions are designed, for example, to be visible and interpretable to humans. There may be chat rooms or forums for communication between the agents. The forums or chat rooms may specialize in specific topics. There may also be 1:1 communication between agents.

A third implementation variant provides a system comprising multiple users, with each user potentially operating their own MAS. These user-specific MAS can work together across devices or applications, and can thus enable the exchange of solutions between users. Moreover, the agents within this variant can specialize on the basis of the type of application or class of equipment, e.g. agents responsible for LSM systems, wide-field microscopes or spinning disc confocal systems, instead of being tied to individual users.

A fourth implementation variant relates to finding optimal parameters for an image processing algorithm. User assistance information is thus generated for a software module of the microscopy system (instead of for a hardware module).

A fifth implementation variant relates to the collaborative and/or adversarial interaction of a plurality of agents in order to generate program code for an image processing algorithm.

Each of these implementation variants can include the core functions described in the introduction, including task coordination, dynamic decision making, image analysis, text query, GUI recognition, hardware control and transparent explanation of actions.

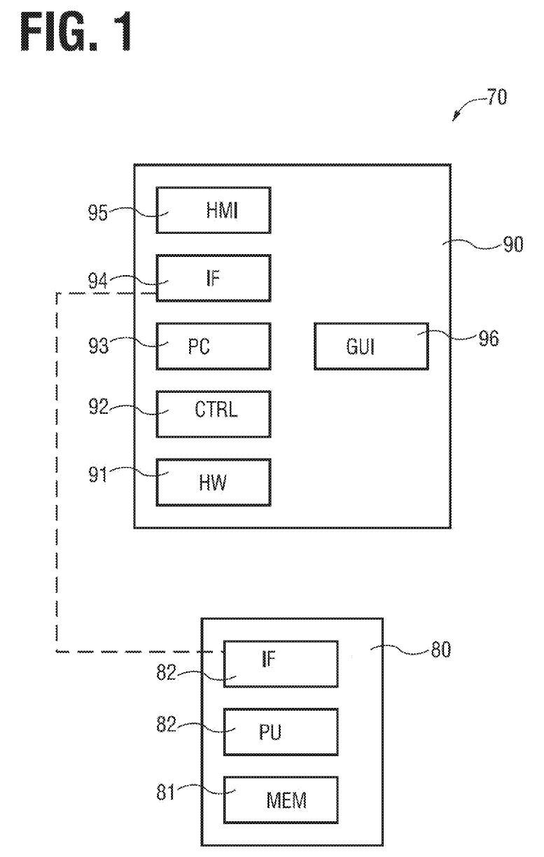

FIG. 1 schematically shows a system 70 according to various examples. The system 70 comprises a microscopy system 90 and an electronic data processing device 80. The microscopy system 90 comprises a plurality of components 91, 92, 93, 94, 95, 96. For example, the microscopy system 90 comprises a microscopy unit 91. The microscopy unit 91 is designed to record microscopic images. For this purpose, the microscopy unit 91 comprises further submodules, for example an illumination module, a sample holder module, a filter module, an objective module, a camera module, etc. The various techniques described herein can be used with different types of microscopy systems 90 and in particular with different types of microscopy units 91. Examples include microscopy units 91 from the following group: light microscope; bright field light microscope; dark field light microscope; phase contrast microscope; light sheet microscope; laser scanning microscope; particle microscope; raster-scanning microscope; atomic force microscope; fluorescence microscope; X-ray microscope; CT microscope, to name just a few.

The microscopy system 90 need not comprise a microscopy unit 91 in all variants. In various variants, it would be conceivable for the microscopy system 70 to be software-implemented and to provide for example one or more image processing modules on a corresponding electronic data processing device.

In the example in FIG. 1, the microscopy system 90 furthermore comprises a control module 92. The control module 92 is designed to control various modules of the microscopy unit 91. For this purpose, the control module 92 can have digital and/or analogue electronics.

The microscopy system 90 furthermore comprises an electronic data processing device 93. For example, the latter can comprise one or more processor units (e.g. CPUs and/or GPUs) and one or more memories. The processor units can load the program code from the memory and execute it. When said one or more processor units execute the program code, this causes said one or more processor units to control the other components of the microscopy system 90. Said one or more processor units can also provide a graphical user interface 96 via a human-machine interface 95, which comprises for example a screen and/or a mouse and/or a keyboard. Moreover, said one or more processor units of the electronic data processing device 93 can also communicate via a communication interface 94. For example, data can be transmitted to a further electronic data processing device 80 and/or data can be received from the further electronic data processing device 80.

The communication between the microscopy system 90 and the electronic data processing device 80 can be effected via a local network and/or via the Internet. For example, the electronic data processing device 80 can be a cloud server.

The electronic data processing device 80 comprises one or more processor units 82 (e.g. CPUs and/or GPUs) and also a memory 81 and a corresponding communication interface 82, which can communicate with the communication interface 94 of the microscopy system 90. The electronic data processing device 80 can be designed to implement an MAS in accordance with various examples described herein.

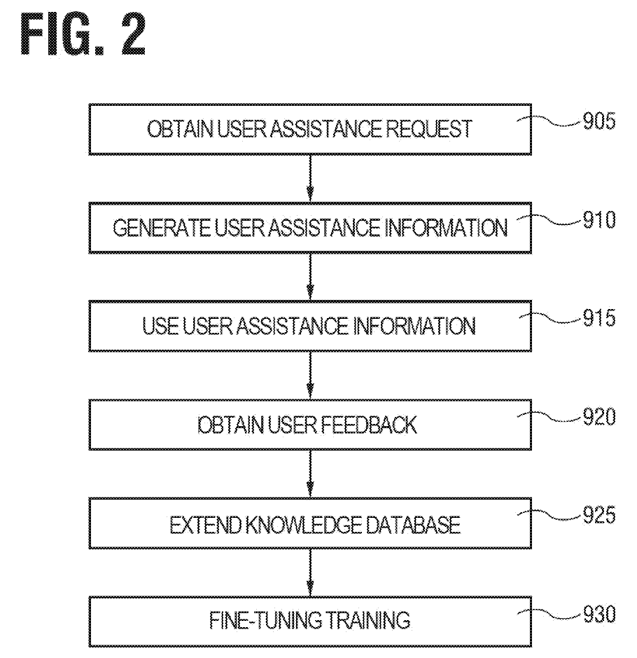

FIG. 2 is a flowchart of one exemplary method. The method from FIG. 2 is used for user assistance during a microscopy task on a microscopy system. For example, the user assistance can be provided for the microscopy system 90 from FIG. 1. All steps of the method from FIG. 2 can be executed in particular by the electronic data processing device 93 of the microscopy system 70 and/or the electronic data processing device 80.

In box 905, a user assistance request is obtained. For example, the user assistance request can be obtained from a user of the microscopy system via a graphical user interface. The user assistance request can be explicitly formulated, for example by the user typing a specific question on operating the microscopy system into a text field of the graphical user interface. However, the user assistance request can also be implicitly formulated, e.g. by the user's interaction with the graphical user interface of the microscopy system being monitored and an interaction pattern between users of the graphical user interface being used as a basis to derive interaction which is of interest for the assistance of the user.

The user assistance information is then generated in box 910. For example, the user assistance information can comprise text information for the user. The user assistance information could also comprise program code.

The user assistance information is generated by means of an MAS. For this purpose, box 910 can comprise for example transferring the user assistance request from box 905 to a corresponding electronic data processing device, which implements the MAS. Referring to the example in FIG. 1: There, the user assistance request or information derived therefrom could be transferred via the communication interface 94 to the electronic data processing device 80. Such communication cannot be unidirectional. During the generation of the user assistance information, for example, queries can be issued to the user and corresponding data can be returned from the electronic data processing device 80 to the electronic data processing device 93 of the microscopy system 90, so that corresponding requests can be output to the user via the graphical user interface 96.

The user assistance information is then used in box 915. For example, the user assistance information or data derived therefrom can be output to a user. For example, a corresponding user instruction could be output to the user via a graphical user interface of the microscopy system. The graphical user interface of the microscopy system could also be reconfigured in accordance with the user assistance information. Specific elements of the user interface can be highlighted. However, the user assistance information need not be output to the user in all variants. For example, the user assistance information can also comprise program code that configures or defines an image evaluation algorithm. In such a case, the program code could be transferred e.g. to a corresponding software module of the microscope system, so that this can then execute the image evaluation on the basis of the program code.

For example, the user assistance information can be translated into a control instruction to the microscopy system or used as a control instruction for the microscopy system. On the basis of the user assistance information, one or more functionalities and/or components of the microscopy system can thus be controlled. For example, a specific imaging modality could be activated. For example, specific filters can be moved into the optical beam path or removed from the optical beam path. For example, a specific illumination could be set. Specific image capture parameters of a camera chip of the microscopy system could be set. A specific image processing algorithm could be loaded and applied. The control of the microscopy system on the basis of the user assistance information can be effected fully or partially automatically. For example, in the context of the use of the user assistance information, a specific recommendation for the setting of one or more components of the microscopy system could be output to a user and the user could accept the use of this setting. This would correspond to a partially automatic setting of one or more components or one or more functionalities of the microscopy system on the basis of the user assistance information. The user could also be enabled to modify one or more parameter values of the proposed setting (for example by the display of specific interface elements of the graphical user interface that are initialized to a specific value, this specific value being ascertained on the basis of the user assistance information). Continuous user guidance in using the microscopy system by means of the user assistance information generated on the basis of the MAS can be made possible in this way. At the same time, depending on whether the control of said one or more components and/or said one or more functionalities of the microscopy system is carried out fully or partially automatically, a higher or lower degree of transparency of the settings can be output to the user. For example, the corresponding setting of the degree of transparency in conjunction with the use of specific settings might depend on a user's ability or a user’s experience value.

In box 915, background information in connection with the user assistance information can also be output to a user. This can help the user to understand how the user assistance information came about. For example, a chat history of at least one or more chat rooms in which the various agents converse by means of the LLM could be output.

In box 920, optionally – explicit or implicit – user feedback on user assistance information is obtained. For example, a user interaction with the graphical user interface of the microscopy system after using user assistance information in box 915 could be monitored. The user feedback can then be determined on the basis of this monitoring of the user information. However, explicit user feedback could also be obtained from the user.

The user feedback could then be stored, for example in combination with the user assistance information and/or the user assistance request, in one or more knowledge databases to which the MAS has access (box 925). Alternatively or additionally, the user assistance request and/or the user assistance information could optionally be stored depending on the user feedback, for example in order to supplement the knowledge database with positive examples and/or negative examples ("question-answer pairs").

In box 930, a fine-tuning training of one or more models to which the multi-MAS has access can take place. For example, the LLMs that implement the communication of the agents of the multi-agent system could be trained, for example by means of LORA. However, microscopy-specific models that are specifically assigned to individual agents, for example image evaluation models, could also be trained.

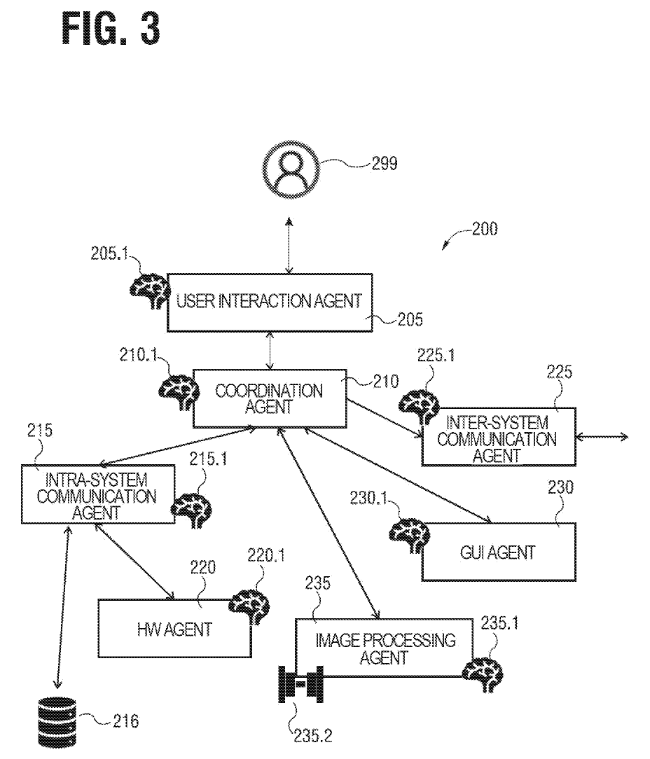

FIG. 3 schematically illustrates aspects in connection with an MAS 200 in accordance with various examples.

The MAS 200 comprises multiple agents 205, 210, 215, 220, 225, 230, 235. Each of the agents equates to a respective large learned text model 205.1, 210.1, 215.1, 220.1, 225.1, 230.1, 235.1.

In detail: In the scenario in FIG. 3, the MAS 200 comprises a user interaction agent entrusted with interacting with a user 299, for example for the purpose of obtaining context information concerning a user assistance request.

The MAS 200 additionally comprises a coordination agent 210 entrusted for example with coordinating one or more further agents of the MAS 200 for processing respective subtasks.

The MAS 200 furthermore comprises a communication agent 215 designed to obtain prior knowledge concerning the microscopy task. For this purpose, the communication agent 215 can access a knowledge database 216, for example. By way of example, RAG techniques can be used. The knowledge database 216 can comprise knowledge elements present in a coded representation, for example in a machine-learned feature space. Longer context lengths for the processing LLM 215.1 can be made possible in this way.

The communication agent 215 also communicates with a control agent 220 entrusted with access to a control module of a microscopy unit of the microscopy system (cf. FIG. 1: control module 92). In this way, the control agent 220 can read out or modify specific configurations, for example. For example, the control agent 220 could be designed to generate corresponding control code for controlling the control module; the LLM 220.1 can be used for this purpose.

The MAS 200 additionally comprises a communication agent 225 capable of communicating with other MAS (not shown in FIG. 3). In this way, for example, prior knowledge for a microscopy task can be acquired by communication with other communication agents from other MAS. Such other MAS can be associated with other types of microscopy systems.

In the example in FIG. 3, the MAS 200 also comprises a GUI agent 230 entrusted with access to a configuration interface of a graphical user interface of the microscopy system (cf. FIG. 1: graphical user interface 96). In this way, the GUI assistant 230 can read out or modify various settings of the graphical user interface.

Finally, in the example in FIG. 3, the MAS 200 also comprises an image processing agent 235 entrusted for example with generating program code for a control module and/or for an image evaluation module of the microscopy system. In addition, the image processing agent could also access an image processing model 235.2, for example in order to process microscope images, evaluate them, etc.

One example of the communication between the various agents of the MAS 200 is presented below. For example, the user interaction agent 205 might obtain a user assistance request from the user 299 that reads: "The cell nuclei should appear brighter in the microscope image." The user interaction agent 205 can then forward the corresponding user request to the coordination agent 210, for example after corresponding pre-processing. The coordination agent 210 then contacts the communication agent 215: "What possibilities are there to make the cell nuclei appear brighter in a microscope image?" The communication agent 215 can then access the knowledge database 216 in order to find knowledge elements in connection with cell nuclei and the brightness of cell nuclei in the microscope image. For example, one knowledge element might be a manual that describes that cell nuclei in microscope images are rendered with particularly good contrast by the so-called Airy scan imaging modality. Accordingly, the communication agent 215 could then ask the control agent 220 whether this imaging modality is available in the present microscopy system. The control agent 220 could check this on the basis of internal configuration files concerning the microscopy system and return the following as an answer: "Yes, the microscopy system supports Airy scans."

In addition to such a possibility of changing the imaging modality by communication with the communication agent 215, the coordination agent 210 can also attempt to increase the brightness by suitable image post-processing. For this purpose, the coordination agent 210 can issue a corresponding request to the image processing agent 235: "Please create a program code that increases the brightness of the cell nuclei in the microscope images captured last, and execute this program code." The image processing agent 235 can then do this.

The coordination agent 210 can also communicate with the GUI agent 230 in order to check whether the screen brightness curve of a corresponding workspace of the graphical user interface where the microscope images are displayed can be adapted to make bright histogram regions appear even brighter.

On the basis of the feedback from the communication agent 215, the coordination agent 210 can also start a corresponding communication with the communication agent 225 (which undertakes the communication with other MAS). For example, the coordination agent 210 can instruct the communication agent 225 to ask other MAS whether these MAS have experience with the "Airy scan" imaging modality. The cross-system communication agent 225 can then make the entry "Who has experience with Airy scan? Especially in connection with the imaging of cell nuclei?”

Another corresponding inter-system communication agent of another MAS might then answer: "I recently used the following hardware settings and was given positive user feedback on them." Such information could then in turn be propagated by the coordination agent 110 to the control agent 220. The knowledge database 216 could be extended accordingly, if appropriate.

In summary, a description has been given of a network of AI agents ("artificial intelligence") which accomplish a task given by the user. Each AI agent can process, store and pass on data, accomplishes a specific (sub)task, and can potentially communicate with any other agent. While all agents can belong to only one microscopy system, it is likewise possible for AI agents from different microscopy systems to communicate with one another.

An essential part of the network is that solutions to problems that cannot be solved for agents operating in isolation can also be learned.

Summarizing at least the following CLAUSES have been disclosed.

CLAUSE 1. A computer-implemented method for user assistance in carrying out a microscopy task on a microscopy system, wherein the method comprises:

obtaining a user assistance request in connection with the microscopy task

on the basis of the user assistance request, generating user assistance information, and

using the user assistance information,

wherein generating the user assistance information comprises using an agent system assigned to the microscopy system, wherein agents of the agent system are designed to process a respective subtask by interaction with one or more large learned text models and to generate the user assistance information jointly by mutual communication of corresponding processing results.

CLAUSE 2. The computer-implemented method according to CLAUSE 1,

wherein a communication agent of the agent system is entrusted with acquiring prior knowledge concerning the microscopy task.

CLAUSE 3. The computer -implemented method according to CLAUSE 2,

wherein the communication agent for acquiring the prior knowledge concerning the microscopy task is entrusted with communication with one or more further communication agents of one or more further agent systems assigned to one or more further microscopy systems.

CLAUSE 4. The computer -implemented method according to CLAUSE 3,

wherein said one or more further microscopy systems and the microscopy system are connected to one another in a local network or via the Internet.

CLAUSE 5. The computer -implemented method according to CLAUSE 3,

wherein a type of said one or more further microscopy systems is different from the type of the microscopy system.

CLAUSE 6. The computer -implemented method according to CLAUSE 3,

wherein a privacy agent of the agent system is entrusted with monitoring and enforcing a confidentiality policy when the communication agent communicates with said one or more further communication agents.

CLAUSE 7. The computer -implemented method according to CLAUSE 2,

wherein the communication agent is entrusted with access to at least one knowledge database associated with the microscopy system for acquiring the prior knowledge.

CLAUSE 8. The computer -implemented method according to CLAUSE 7,

wherein the at least one knowledge database comprises a plurality of knowledge elements represented in a machine-learned feature space.

CLAUSE 9. The computer -implemented method according to CLAUSE 7,

wherein an accountant agent of the agent system is entrusted with maintaining and/or extending the at least one knowledge database on the basis of user feedback on the user assistance information.

CLAUSE 10. The computer -implemented method according to CLAUSE 7,

wherein the at least one knowledge database comprises knowledge items selected from the following group: user manual of one or more components of the microscopy system; historical user assistance requests and/or historical user assistance information; technical papers; Wiki articles; log files of one or more components of the microscopy system; user-specific information; sample-specific information; information on a manufacturing process associated with the sample; microscopy system-specific information.

CLAUSE 11. The computer -implemented method according to CLAUSE 1, wherein the method furthermore comprises:

obtaining user feedback on the user assistance information, and

depending on the user feedback, storing at least one of the user assistance request, the user assistance information and the user feedback in a knowledge database to which at least one agent of the agent system has access.

CLAUSE 12. The computer -implemented method according to CLAUSE 1,

wherein a GUI agent of the agent system is entrusted with access to a configuration interface of a graphical user interface of the microscopy system for querying a configuration and/or for setting the configuration of the graphical user interface.

CLAUSE 13. The computer -implemented method according to CLAUSE 1,

wherein a control agent of the agent system is entrusted with access to a control module of at least one microscopy unit of the microscopy system, wherein the control module is designed to configure and trigger an image capture of microscope images by means of the microscopy system.

CLAUSE 14. The computer -implemented method according to CLAUSE 1,

wherein a program code agent of the agent system is entrusted with generating program code for a control module of at least one microscopy unit of the microscopy system or for an image evaluation module of the microscopy system.

CLAUSE 15. The computer -implemented method according to CLAUSE 1,

wherein a coordination agent of the agent system is entrusted with coordinating one or more further agents of the agent system for the processing of the respective subtasks.

CLAUSE 16. The computer -implemented method according to CLAUSE 1,

wherein a user interaction agent of the agent system is entrusted with the user interaction for obtaining context information concerning the user assistance request.

CLAUSE 17. The computer -implemented method according to CLAUSE 1,

wherein an image analysis agent of the agent system is entrusted with evaluating microscope images captured by means of the microscopy system by access to one or more image processing models.

CLAUSE 18. The computer -implemented method according to CLAUSE 1,

wherein two or more agents of the agent system are entrusted with acting adversarially in the processing of the respective subtasks, and/or

wherein two or more agents of the agent system are entrusted with acting collaboratively in the processing of the respective subtasks.

CLAUSE 19. The computer -implemented method according to CLAUSE 1,

wherein the agent system is designed to enable communication between the agents by means of textual communication elements obtained by the interaction of the agents with the or a plurality of large learned text models.

CLAUSE 20. The computer -implemented method according to CLAUSE 19,

wherein the textual communication elements are written in technical language and/or according to a predefined communication code and/or in a machine-learned feature space.

CLAUSE 21. The computer -implemented method according to CLAUSE 1,

wherein the agent system is designed to provide one or more chat rooms for communication between the agents.

CLAUSE 22. The computer -implemented method according to CLAUSE 21,

wherein said one or more chat rooms comprise at least one instance-specific chat room associated with the respective user assistance request, and/or

wherein said one or more chat rooms comprise at least one cross-instance chat room associated with a plurality of user assistance requests, and/or

wherein said one or more chat rooms comprise at least one topic-specific chat room associated with a specific subtask.

CLAUSE 23. The computer -implemented method according to CLAUSE 21,

wherein the method furthermore comprises:

outputting a chat history in at least one of said one or more chat rooms via a user interface.

CLAUSE 24. The computer -implemented method according to CLAUSE 1, wherein the method furthermore comprises:

obtaining user feedback on the user assistance information, and

depending on the user feedback, performing a fine-tuning training for at least one machine-learned model to which at least one agent of the agent system has access.

CLAUSE 25. The computer -implemented method according to CLAUSE 24,

wherein the fine-tuning training comprises a LoRA fine-tuning training of at least one of said one or more large learned text models.

CLAUSE 26. The computer -implemented method according to CLAUSE 1, wherein the method furthermore comprises:

monitoring a user interaction with a graphical user interface of the microscopy system after using the user assistance information, and

determining user feedback on the basis of monitoring the user interaction.

CLAUSE 27. The computer -implemented method according to CLAUSE 1,

wherein the user assistance information comprises an operating instruction for using one or more user interface elements of a graphical user interface of the microscopy system.

CLAUSE 28. The computer -implemented method according to CLAUSE 1,

wherein the user assistance information comprises program code for a control module of at least one microscopy unit of the microscopy system or for an image evaluation module of the microscopy system.

CLAUSE 29. The computer -implemented method according to CLAUSE 1,

wherein the user assistance information comprises a setting of one or more hardware or software parameters for image recording or image processing of microscope images by means of the microscopy system.

CLAUSE 30. The computer -implemented method according to CLAUSE 1,

wherein the user assistance information comprises a user instruction for outputting to a user.

CLAUSE 31. The computer -implemented method according to CLAUSE 1,

wherein the agent system is assigned to a user.

CLAUSE 32. The computer -implemented method according to CLAUSE 1,

wherein at least one agent of the agent system is entrusted with accomplishing the respective subtask by accessing a corresponding domain-specific model.

CLAUSE 33. The computer -implemented method according to CLAUSE 1,

wherein the different agents of the agent system are associated with different executable functions and/or different rights.

CLAUSE 34. An electronic data processing device comprising at least one processor unit and a memory, wherein the at least one processor unit is designed to load program code from the memory and to execute it, wherein the at least one processor unit executes the method according to CLAUSE 1 on the basis of executing the program code.

It goes without saying that the features of the embodiments and aspects of the invention described above can be combined with one another. In particular, the features can be used not only in the combinations described but also in other combinations or on their own, without departing from the scope of the invention.

What is claimed is:

1. A computer-implemented method for user assistance in carrying out a microscopy task on a microscopy system, wherein the method comprises:
obtaining a user assistance request in connection with the microscopy task
on the basis of the user assistance request, generating user assistance information, and
using the user assistance information,
wherein generating the user assistance information comprises using an agent system assigned to the microscopy system, wherein agents of the agent system are designed to process a respective subtask by interaction with one or more large learned text models and to generate the user assistance information jointly by mutual communication of corresponding processing results.

2. The computer-implemented method according to claim 1,
wherein a communication agent of the agent system is entrusted with acquiring prior knowledge concerning the microscopy task.

3. The computer -implemented method according to claim 2,
wherein the communication agent for acquiring the prior knowledge concerning the microscopy task is entrusted with communication with one or more further communication agents of one or more further agent systems assigned to one or more further microscopy systems.

4. The computer -implemented method according to claim 3,
wherein a type of said one or more further microscopy systems is different from the type of the microscopy system.

5. The computer -implemented method according to claim 3,
wherein a privacy agent of the agent system is entrusted with monitoring and enforcing a confidentiality policy when the communication agent communicates with said one or more further communication agents.

6. The computer -implemented method according to claim 2,
wherein the communication agent is entrusted with access to at least one knowledge database associated with the microscopy system for acquiring the prior knowledge.

7. The computer -implemented method according to claim 6,
wherein the at least one knowledge database comprises a plurality of knowledge elements represented in a machine-learned feature space.

8. The computer -implemented method according to claim 6,
wherein an accountant agent of the agent system is entrusted with maintaining and/or extending the at least one knowledge database on the basis of user feedback on the user assistance information.

9. The computer -implemented method according to claim 6,
wherein the at least one knowledge database comprises knowledge items selected from the following group: user manual of one or more components of the microscopy system; historical user assistance requests and/or historical user assistance information; technical papers; Wiki articles; log files of one or more components of the microscopy system; user-specific information; sample-specific information; information on a manufacturing process associated with the sample; microscopy system-specific information.

10. The computer -implemented method according to claim 1, wherein the method furthermore comprises:
obtaining user feedback on the user assistance information, and
depending on the user feedback, storing at least one of the user assistance request, the user assistance information and the user feedback in a knowledge database to which at least one agent of the agent system has access.

11. The computer -implemented method according to claim 1,
wherein a GUI agent of the agent system is entrusted with access to a configuration interface of a graphical user interface of the microscopy system for querying a configuration and/or for setting the configuration of the graphical user interface.

12. The computer -implemented method according to claim 1,
wherein a control agent of the agent system is entrusted with access to a control module of at least one microscopy unit of the microscopy system, wherein the control module is designed to configure and trigger an image capture of microscope images by means of the microscopy system.

13. The computer -implemented method according to claim 1,
wherein a program code agent of the agent system is entrusted with generating program code for a control module of at least one microscopy unit of the microscopy system or for an image evaluation module of the microscopy system.

14. The computer -implemented method according to claim 1,
wherein a coordination agent of the agent system is entrusted with coordinating one or more further agents of the agent system for the processing of the respective subtasks.

15. The computer -implemented method according to claim 1,
wherein a user interaction agent of the agent system is entrusted with the user interaction for obtaining context information concerning the user assistance request.

16. The computer -implemented method according to claim 1,
wherein an image analysis agent of the agent system is entrusted with evaluating microscope images captured by means of the microscopy system by access to one or more image processing models.

17. The computer -implemented method according to claim 1,
wherein the agent system is designed to provide two or more chat rooms for communication between the agents,
wherein said two or more chat rooms comprise two or more of the following:
an instance-specific chat room associated with the respective user assistance request,
a cross-instance chat room associated with a plurality of user assistance requests, or
a topic-specific chat room associated with a specific subtask.

18. The computer -implemented method according to claim 1,
wherein the user assistance information comprises program code for a control module of at least one microscopy unit of the microscopy system or for an image evaluation module of the microscopy system.

19. The computer -implemented method according to claim 1,
wherein the user assistance information comprises a setting of one or more hardware or software parameters for image recording or image processing of microscope images by means of the microscopy system.

20. An electronic data processing device comprising at least one processor unit and a memory, wherein the at least one processor unit is designed to load program code from the memory and to execute it, wherein the at least one processor unit executes the method according to claim 1 on the basis of executing the program code.
